(19) United States
(12) Patent Application Publication
(10) Pub. No.: US 2026/0062319 A1
(43) Pub. Date: Mar. 5, 2026

(54) ECOLOGICAL DAM FOR NITROGEN FIXATION AND PHOSPHORUS REDUCTION BASED ON MODIFIED ALUMINOSILICATE INORGANIC MESOPOROUS MATERIAL

(71) Applicants: Suzhou University of Science and Technology, Suzhou (CN); China Water Resources and Environment Research Institute (Suzhou) Co., Ltd, Kunshan (CN)

(72) Inventors: Cuimei Li, Suzhou (CN); Shaoguang Zhang, Kunshan (CN); Hao Wang, Kunshan (CN)

(21) Appl. No.: 19/180,094

(22) Filed: Apr. 15, 2025

(30) Foreign Application Priority Data
Aug. 30, 2024 (CN) 202411207942.7

(51) Int. Cl. C02F 1/28; B01J 20/16; B01J 20/22; B01J 20/28; B01J 20/30; C02F 3/34; C02F 101/10; C02F 101/16; C02F 103/00

(52) U.S. Cl. CPC C02F 1/288; B01J 20/16; B01J 20/22; B01J 20/28019; B01J 20/28052; B01J 20/28059; B01J 20/3021; B01J 20/3071; B01J 20/3078; C02F 3/34; C02F 1/281; C02F 1/286; C02F 2101/105; C02F 2101/16; C02F 2103/007

(57) ABSTRACT

An ecological dam for nitrogen fixation and phosphorus reduction based on a modified aluminosilicate inorganic mesoporous material includes an ecological adsorption module and a fixing module. The ecological adsorption module includes multiple ecological adsorption ball components prepared from the modified aluminosilicate inorganic mesoporous material, and the ecological adsorption module is configured to adsorb pollutants in the river channel. The fixing module is configured to fix the ecological adsorption module into the river channel to be treated. Each ecological adsorption ball component includes floating balls, and the modified aluminosilicate inorganic mesoporous material is in the floating balls. In water with dissolved oxygen over 2 mg/L, the ecological adsorption ball components can rapidly adsorb ammonia-nitrogen and total phosphorus and can quickly form a large aerobic microbial membrane for long-term purification and degradation of pollutants, enhancing a self-purification ability of the water under low-release nitrifying bacteria solid balls.

### CROSS-REFERENCE TO RELATED APPLICATION

This application claims priority to Chinese Patent Application No. 202411207942.7, filed Aug. 30, 2024, which is herein incorporated by reference in its entirety.

### TECHNICAL FIELD

The disclosure relates to the technical field of sewage disposal, and particularly to an ecological dam for nitrogen fixation and phosphorus reduction based on a modified aluminosilicate inorganic mesoporous material.

### BACKGROUND

Urban rivers contain high concentrations of pollutants like ammonia-nitrogen and total phosphorus, which are highly dissolved, micro-sized and difficult to manage. Traditional river-treatment methods focusing on end-of-pipe treatment can't fundamentally solve deterioration of water quality. In recent years, ecological dams, as a new water-purification technology, have gained wide attention due to their eco-friendliness and sustainability.

However, existing ecological dam technologies still have many drawbacks in practice. First, the traditional ecological dams are often built with materials like gravel and rubble, which is hard to construct and may hinder navigation. Second, the traditional ecological dams are prone to pollutant siltation and permeable material clogging, requiring regular maintenance and increasing operating costs. Moreover, their removal effect on highly dissolved and micro-sized pollutants like ammonia-nitrogen is limited, falling short of the ever-stricter standards of water quality.

In addition, some ecological dams with purification functions can only improve the water quality to a certain extent. Their purification is often limited by capacity of adsorption material and microbial activity, with a short effective time and high construction cost, hindering large scale promotion.

Therefore, it is necessary to provide a new technological solution to address the shortcomings of the traditional ecological dams in river water management.

### SUMMARY

The disclosure aims to address the shortcomings of traditional ecological dams in river water management through technological innovation, and provide a new solution for improving river water quality.

To achieve the above objectives, the technical solutions of the disclosure are as follows.

An ecological dam for nitrogen fixation and phosphorus reduction based on a modified aluminosilicate inorganic mesoporous material includes an ecological adsorption module and a fixing module. The ecological adsorption module is located in a river channel to be treated, the ecological adsorption module includes multiple ecological adsorption ball components prepared from the modified aluminosilicate inorganic mesoporous material, and the ecological adsorption module is configured to adsorb pollutants in the river channel to be treated. The fixing module is disposed in the river channel to be treated, and the fixing module includes multiple vertical fixing piles and multiple horizontal support angle steels. The multiple vertical fixing piles are arranged in two symmetrical rows on two riverbanks of the river channel to be treated, any two vertical fixing piles symmetrically arranged of the multiple vertical fixing piles is fixed with a corresponding one of the multiple horizontal support angle steels therebetween, and the multiple ecological adsorption ball components of the ecological adsorption module are mounted on the multiple horizontal support angle steels.

In an embodiment, a specific surface area of the modified aluminosilicate inorganic mesoporous material is in a range of 30 square meters per gram (m²/g) to 40 m²/g.

In an embodiment, each ecological adsorption ball component includes a sinking ball and multiple floating balls vertically connected in series from a water bottom (also referred to as river bottom) to a water surface in the river channel to be treated.

In an embodiment, each floating ball includes a spherical shell including an outer shell and an inner shell adjacent thereto, the outer shell is a grid shell with a grid aperture of 1 centimeter (cm)×2 cm, and the inner shell is made of an 80-mesh nylon fabric. The spherical shell defines a hollow sphere cavity, the hollow sphere cavity is sequentially filled with a layer of the modified aluminosilicate inorganic mesoporous material and a pearl cotton layer from bottom to top, multiple slow-release nitrifying bacteria solid balls are filled in the pearl cotton layer, and the layer of the modified aluminosilicate inorganic mesoporous material includes, from bottom to top, three sub-layers of the modified aluminosilicate inorganic mesoporous material with particle sizes of 2 cm to 4 cm, 1 cm to 2 cm, and 1 millimeter (mm) to 4 mm.

In an embodiment, a weight ratio of the layer of the modified aluminosilicate inorganic mesoporous material to the pearl cotton layer is in a range of 50:1 to 70:1, and a weight ratio of the pearl cotton layer to the multiple slow-release nitrifying bacteria solid balls is in a range of 0.5 to 1.

In an embodiment, a weight of the layer of the modified aluminosilicate inorganic mesoporous material is 1.5 kilograms (kg), a weight of the pearl cotton layer is 25 grams (g), and a weight of the multiple slow-release nitrifying bacteria solid balls is 40 g. Specifically, the pearl cotton is cylindrical, with a diameter of 2.2 cm and a height of 5 cm, and a diameter of each slow-release nitrifying bacteria solid ball is 3 cm.

In an embodiment, the sinking ball includes a spherical shell including an outer shell and an inner shell adjacent thereto, the outer shell is a grid shell with a grid aperture of 1 cm×2 cm, and the inner shell is made of an 80-mesh nylon fabric. The spherical shell defines a hollow sphere cavity, the hollow sphere cavity is sequentially filled with a layer of the modified aluminosilicate inorganic mesoporous material and multiple slow-release nitrifying bacteria solid balls, and the layer of the modified aluminosilicate inorganic mesoporous material includes, from bottom to top, three sub-layers of the modified aluminosilicate inorganic mesoporous material with particle sizes of 2 cm to 4 cm, 1 cm to 2 cm, and 1 mm to 4 mm. The three sub-layers of the modified aluminosilicate inorganic mesoporous material with the particle sizes of 2 cm to 4 cm, 1 cm to 2 cm, and 1 mm to 4 mm are prepared from the modified aluminosilicate inorganic mesoporous material with the specific surface area in the range of 30 m²/g to 40 m²/g.

In an embodiment, a weight ratio of the layer of the modified aluminosilicate inorganic mesoporous material to the multiple slow-release nitrifying bacteria solid balls is in a range of 0.02 to 0.03.

In an embodiment, a distance between adjacent two of the multiple vertical fixing piles on a same row is 50 cm, lower ends of the multiple vertical fixing piles are at least 1 meter (m) deep into the water bottom of the river channel to be treated, and upper ends of the multiple vertical fixing piles are in a range of 25 cm to 35 cm deep into the water surface of the river channel to be treated.

In an embodiment, each horizontal support angle steel defines laser holes, a diameter of each laser hole is in a range of 0.4 cm to 0.6 cm, and a distance between adjacent two of the laser holes is 15 cm.

To achieve the above objectives, the disclosure further provides a preparation method of the inorganic mesoporous material of modified aluminosilicates including steps as follows.
S1: aluminosilicate is crushed to obtain aluminosilicate particles, and the aluminosilicate particles in a range of 80 meshes to 100 meshes are selected.
S2, the aluminosilicate particles from the step S1 are soaked in a nitrate solution with a concentration of 1 mole per liter (mol/L) to 6 mol/L for 12 hours (h) to 24 h to obtain a mixed solution, and a volume of the nitrate solution corresponding to 1 g of the aluminosilicate particles is in a range of 10 milliliters (mL) to 60 mL. The mixed solution is filtered to obtain filtered particles, followed by drying the filtered particles at a temperature in a range of 95° C. to 110° C., and then the filtered particles after the drying are calcined at a temperature in a range of 400° C. to 500° C. for 1 h to 2 h to obtain primary modified aluminosilicate particles.
S3, the primary modified aluminosilicate particles from the step S2 are soaked in a chitosan solution with a mass concentration in a range of 3% to 5% at a temperature in a range of 40° C. to 60° C. for 0.5 h to 3 h, then the chitosan solution soaked with the primary modified aluminosilicate particles are filtered to obtain filtered primary modified aluminosilicate particles, followed by washing the filtered primary modified aluminosilicate particles with water to obtain washed primary modified aluminosilicate particles, and drying the washed primary modified aluminosilicate particles at a temperature in a range of 95° C. to 110° C. to obtain the modified aluminosilicate inorganic mesoporous material.

In an embodiment, a specific surface area of the aluminosilicates is 14 m²/g to 16 m²/g.

In an embodiment, the aluminosilicate is at least one of sodium aluminosilicate, potassium aluminosilicate, and calcium aluminosilicate.

In an embodiment, in the step S2, nitrate in the nitrate solution is sodium nitrate or potassium nitrate.

In an embodiment, in the step S2, a concentration of the nitrate solution is 4 mol/L, a volume of the nitrate solution corresponding to 1 g of the aluminosilicate particles is 40 mL, and a time for the soaking is 12 h.

In an embodiment, in the step S2, a temperature of the calcining is 400° C., and a time for the calcining is 1 h.

In an embodiment, in the step S3, the chitosan solution is an alkaline chitosan solution with a hydrogen ion concentration (pH) value of 9.5 to 10.5.

In an embodiment, in the step S3, a mass concentration of the chitosan solution is 5%, a temperature of the chitosan solution is 50° C., and a time for the soaking in the chitosan solution is 1 h.

To achieve above objectives, a modified aluminosilicate inorganic mesoporous material is provided.

In an embodiment, a specific surface area of the modified aluminosilicate inorganic mesoporous material is 30 m²/g to 40 m²/g.

The beneficial effects of the disclosure are as follow.

The disclosure provides a preparation method of the modified aluminosilicate inorganic mesoporous material. Through nitrate calcination modification, alkaline chitosan modification, and by adjusting parameters such as silicate particle size, specific surface area, nitrate solution concentration, solid-liquid ratio of aluminosilicate particles to nitrate solution, calcination time, calcination temperature, pH value of chitosan solution, mass fraction of chitosan solution, and temperature of chitosan solution, it can stably prepare the modified aluminosilicate inorganic mesoporous material with a specific surface area in a range of 30 m²/g to 40 m²/g. An internal pore size of the modified aluminosilicate inorganic mesoporous material can be as small as a sub-nanometer level.

The disclosure provides an ecological dam for nitrogen fixation and phosphorus reduction based on a modified aluminosilicate inorganic mesoporous material. The ecological dam includes an ecological adsorption module with multiple ecological adsorption ball components made of the material for adsorbing river pollutants. Each ecological adsorption ball component includes floating balls. In water with dissolved oxygen over 2 milligrams per liter (mg/L), the ecological adsorption ball components can rapidly adsorb ammonia-nitrogen, total phosphorus, etc. In addition, under functions of the low-release nitrifying bacteria solid balls, the ecological adsorption ball components can quickly form a large aerobic microbial membrane for long-term purification and degradation of pollutants, enhancing a self-purification ability of the water.

According to the degree of water pollution, the floating balls has a service life of more than one year. After use, the floating balls can be cleaned with salt water and can be recycled without the need to add repair agents to the river. It does not consume electricity, is green and energy-saving, and does not cause secondary pollution.

The fixing module is conducive to quickly installing the ecological adsorption module onto the river channel to be treated, with simple construction, no excavation, precipitation, underwater operations, cofferdam layout, and large mechanical operations, and low construction costs.

The ecological dam for nitrogen fixation and phosphorus reduction based on a modified aluminosilicate inorganic mesoporous material of the disclosure is suitable for water bodies with a flow velocity less than 0.4 meters per second (m/s).

### BRIEF DESCRIPTION OF DRAWINGS

FIG. 1 illustrates a schematic structural diagram from a perspective of top view of an ecological dam for nitrogen fixation and phosphorus reduction according to an embodiment 1.

FIG. 2 illustrates a schematic structural diagram from a perspective of front view of the ecological dam for nitrogen fixation and phosphorus reduction according to the embodiment 1.

FIG. 3 illustrates a schematic structural diagram of a horizontal support angle steel according to the embodiment 1.

FIG. 4 illustrates a schematic structural diagram from a perspective of front view of a vertical fixing pile according to the embodiment 1.

FIG. 5 illustrates a three-dimensional schematic structural diagram of a floating ball according to the embodiment 1.

FIG. 6 illustrates a schematic diagram of a cross-sectional structure of the floating ball according to the embodiment 1.

FIG. 7 illustrates a scanning electron microscope (SEM) image of an internal pore structure of a modified aluminosilicate inorganic mesoporous material according to an embodiment 3.

FIG. 8 illustrates a transmission electron microscope (TEM) image of the internal pore structure of the modified aluminosilicate inorganic mesoporous material according to the embodiment 3.

### DESCRIPTION OF REFERENCE SIGNS

1. vertical fixing pile; 2. horizontal support angle steel; 3. ecological adsorption ball component; 101. first steel pipe; 102. second steel pipe; 103. third steel pipe; 21. laser hole; 4. floating ball; 41. outer shell; 42. inner shell; 43. layer of the modified aluminosilicate inorganic mesoporous material; 44. pearl cotton (i.e., expanded polyethylene, abbreviated as EPE) layer; 45. slow-release nitrifying bacteria solid ball.

### DETAILED DESCRIPTION OF EMBODIMENTS

The following will provide a clear and complete description of the technical solutions in the embodiments of the disclosure. Apparently, the described embodiments are only a part of the embodiments of the disclosure, not all of them. Based on the embodiments in the disclosure, all other embodiments obtained by those skilled in the art without creative labor fall within the scope of protection of the disclosure.

In order to make the above objectives, features, and advantages of the disclosure more obvious and understandable, the following will provide further detailed explanations of the disclosure in conjunction with specific embodiments.

### Embodiment 1

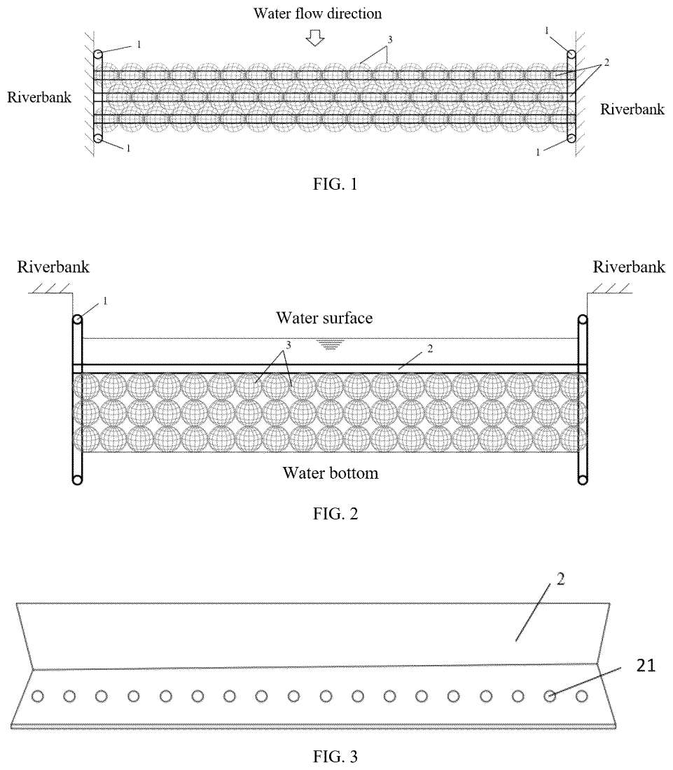

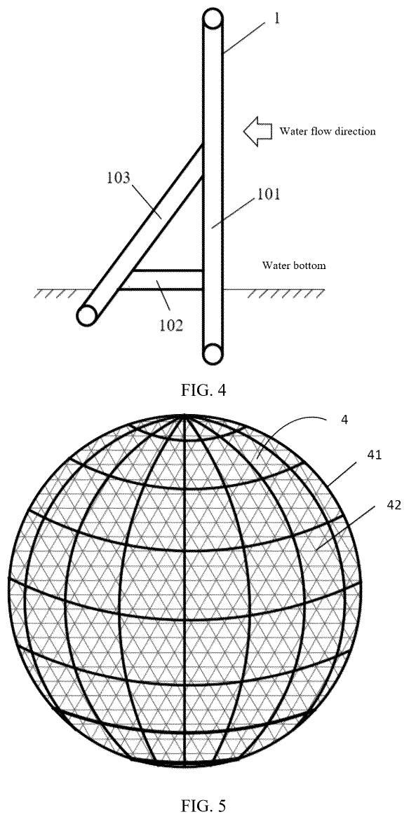

An ecological dam for nitrogen fixation and phosphorus reduction based on a modified aluminosilicate inorganic mesoporous material, as shown in FIGS. 1 and 2, includes an ecological adsorption module and a fixing module. The fixing module includes four vertical fixing piles 1 and two horizontal support angle steels 2. The four vertical fixing piles 1 are arranged in two symmetrical rows on two riverbanks of the river channel to be treated, with two vertical fixing piles 1 on each row, and a distance between adjacent two of the four vertical fixing piles 1 on the same row is 50 cm. Any two vertical fixing piles 1 symmetrically arranged of the four vertical fixing piles 1 is fixed with a corresponding one of the two horizontal support angle steels 2 therebetween, and a surface of each horizontal support angle steel 2 parallel to a water surface direction defines laser holes 21, a diameter of each laser holes 21 is 0.5 cm, and a distance between adjacent two of the laser holes is 15 cm. A schematic structural diagram of the horizontal support angle steels 2 are illustrated in FIG. 3. The ecological adsorption module includes multiple ecological adsorption ball components 3 prepared from the modified aluminosilicate inorganic mesoporous material, and each ecological adsorption ball component 3 includes a sinking ball and multiple floating balls 4 vertically connected in series from a water bottom to a water surface in the river channel to be treated. The sinking ball and multiple floating balls 4 are tied together with zip ties and fixed to the laser holes 21 for adsorbing pollutants in the river. The zip ties are made of nylon, with a specification of 4 mm×200 mm and a thickness of 2 mm.

A pore size of internal pores of the modified aluminosilicate inorganic mesoporous material is in a range of 2 nm to 50 nm, and a specific surface area of the modified aluminosilicate inorganic mesoporous material is 30 m²/g to 40 m²/g.

Each vertical fixing pile 1 is made of galvanized steel pipe. As shown in FIG. 4, the vertical fixing pile 1 includes three steel pipes (101, 102, 103) welded into a triangular shape. A first steel pipe 101 is vertical to the water surface, the second steel pipe 102 is parallel to the water surface, and the third steel pipe 103 is inclined to a water flow direction. The vertical fixing pile 1 in a right-angled triangle is placed with the water flow direction to resist the pressure of the water flow. The second steel pipe 102 is located on the river bottom along the water flow, with a bottom end of the first pipe 101 buried 1 m into the river bottom and a top end of the first pipe 101 30 cm deep into the water surface. The horizontal support angle steel 2, made of 304 stainless steel (50 mm×50 mm×5 mm), is placed 0.8 m below the water surface, perpendicular to the water flow direction.

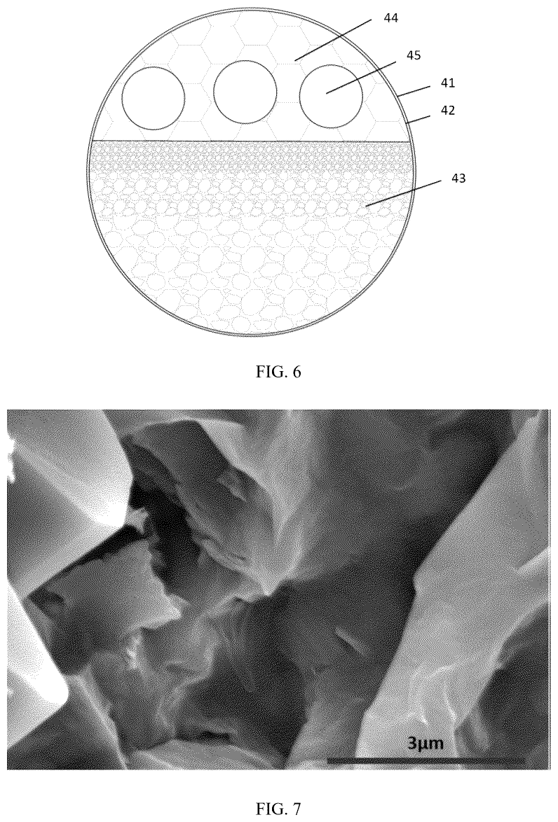

As shown in FIGS. 5 and 6, each floating ball 4 includes a spherical shell including an outer shell 41 and an inner shell 42 adjacent thereto, a diameter of the outer shell 41 is 15 cm, and it is made of polyurethane. The outer shell 41 is a grid shell with a grid aperture of 1 cm×2 cm, and the inner shell 42 is made of an 80-mesh nylon fabric. The function of the inner shell 42 is to prevent an overflow of the pearl cotton and the slow-release nitrifying bacteria solid balls 45. The spherical shell defines a hollow sphere cavity, the hollow sphere cavity is sequentially filled with a layer of the modified aluminosilicate inorganic mesoporous material 43 and a pearl cotton layer 44 from bottom to top, multiple slow-release nitrifying bacteria solid balls 45 are filled in the pearl cotton layer 44, and the layer of the modified aluminosilicate inorganic mesoporous material 43 includes, from bottom to top, three sub-layers of the modified aluminosilicate inorganic mesoporous material with particle sizes of 2 cm to 4 cm, 1 cm to 2 cm, and 1 mm to 4 mm. The three sub-layers of the modified aluminosilicate inorganic mesoporous material 43 with the particle sizes of 2 cm to 4 cm, 1 cm to 2 cm, and 1 mm to 4 mm are prepared from the modified aluminosilicate inorganic mesoporous material with the specific surface area in a range of 30 m²/g to 40 m²/g. A preparation of the modified aluminosilicate inorganic mesoporous material with the specific surface area in a range of 30 m²/g to 40 m²/g is shown in embodiments 3-14.

In each floating ball 4, a weight of the layer of the modified aluminosilicate inorganic mesoporous material 43 is 1.5 kg, including: the sub-layer with particle sizes of 2 cm to 4 cm at 600 g, the sub-layer with particle sizes of 1 cm to 2 cm at 480 g, and the sub-layer with particle sizes of 1 mm to 4 mm at 420 g. A weight of the multiple slow-release nitrifying bacteria solid balls 45 is 40 g, and a number of the multiple slow-release nitrifying bacteria solid balls is three. The pearl cotton layer 44 is in a cylindrical shape, sized at 2.2 cm in diameter and 5 cm in height, and a weight of the pearl cotton layer 44 is 25 g.

The sinking ball includes a spherical shell including an outer shell 41 and an inner shell 42 adjacent thereto, the outer shell 41 is a grid shell with a grid aperture of 1 cm×2 cm. A diameter of the outer shell 41 is 15 cm, it is made of polyurethane and the inner shell 42 is made of an 80-mesh nylon fabric. The function of the inner shell 42 is to prevent the overflow of pearl cotton and slow-release nitrifying bacteria solid balls 45. The spherical shell defines a hollow sphere cavity, the hollow sphere cavity is sequentially filled with a layer of the modified aluminosilicate inorganic mesoporous material 43 and multiple slow-release nitrifying bacteria solid balls 45. The layer of the modified aluminosilicate inorganic mesoporous material 43 includes, from bottom to top, three sub-layers of the modified aluminosilicate inorganic mesoporous material with particle sizes of 2 cm to 4 cm, 1 cm to 2 cm, and 1 mm to 4 mm. The multiple slow-release nitrifying bacteria solid balls 45 are located on the sub-layer of the modified aluminosilicate inorganic mesoporous material 43 with the particle size of 1 mm to 4 mm. The three sub-layers of the modified aluminosilicate inorganic mesoporous material 43 with the particle sizes of 2 cm to 4 cm, 1 cm to 2 cm, and 1 mm to 4 mm are prepared from the modified aluminosilicate inorganic mesoporous material with the specific surface area in a range of 30 m²/g to 40 m²/g. A preparation of the modified aluminosilicate inorganic mesoporous material with the specific surface area in a range of 30 m²/g to 40 m²/g is shown in embodiments 3-14. In the sinking ball, a weight of the layer of modified aluminosilicate inorganic mesoporous material 43 is 3 kg, including: the sub-layer with particle sizes of 2 cm to 4 cm at 1.8 kg, the sub-layer with particle sizes of 1 cm to 2 cm at 0.7 kg, and the sub-layer with particle sizes of 1 mm to 4 mm at 0.5 kg. A weight of the multiple slow-release nitrifying bacteria solid balls 45 is 65 g, and a number of the multiple slow-release nitrifying bacteria solid balls is five.

### Embodiment 2

The ecological dam for nitrogen fixation and phosphorus reduction based on the modified aluminosilicate inorganic mesoporous material from embodiment 1 is installed in a polluted river channel. A target river section length is 500 m, with nearly zero flow rate, an average width of 15 m, an average depth of 2.5 m, a water area of 7500 square meters (m²), and a total water volume of 18750 cubic meters (m³). An initial dissolved oxygen is about 2.3 milligrams per liter (mg/L), chemical oxygen demand (COD) is 82 mg/L, ammonia-nitrogen is 5.3 mg/L, and a total phosphorus is 1.2 mg/L. Three such dams from embodiment 1 are arranged in the river channel according to the river section length. Water quality is tested after 10 days, 30 days, 3 months, and 1 year of operation, with results shown in Table 1.

The test standard for the ammonia-nitrogen is “Determination of ammonia-nitrogen in water quality by Nessler's reagent spectrophotometry HJ 535-2009”, with a detection limit of 0.025 mg/L, tested using a UV-visible spectrophotometer. For the total phosphorus, it's “Determination of total phosphorus in water quality by ammonium molybdate spectrophotometry GB/T 11893-1989”, with a detection limit of 0.01 mg/L, tested using a portable pressure steam sterilizer or UV-visible spectrophotometer. For the dissolved oxygen, it follows “Determination of dissolved oxygen in water quality by electrochemical probe method HJ 506-2009”, tested with a portable dissolved oxygen meter. The COD follows “Determination of chemical oxygen demand in water quality by dichromate method HJ 828-2017”, with a detection limit of 4 mg/L, tested using a COD digester. The transparency is based on “Determination of transparency by disk method SL 87-1994”, tested with a Secchi disk.

TABLE 1
The water sample situation in the target river
section after different operating time periods

| Water quality | Ammonia- | Total | Dissolved | | Trans- |
|---|---|---|---|---|---|
| indicators | nitrogen | phosphorus | oxygen | COD | parency |
| (mg/L) | (mg/L) | (mg/L) | (mg/L) | (mg/L) | (cm) |
| Original water | 5.3 | 1.2 | 2.3 | 82 | 0 |
| sample | | | | | |
| After 10 days | 1.83 | 1.0 | 3.2 | 43 | 15 |
| After 20 days | 1.52 | 0.76 | 4.1 | 32 | 40 |
| After 3 months | 1.1 | 0.68 | 4.3 | 21 | 50 |
| After 1 year | 0.87 | 0.57 | 4.5 | 18 | 60 |

### Embodiment 3

After crushing natural sodium aluminosilicate, sodium aluminosilicate particles with 80 meshes to 100 meshes are screened out. The sodium aluminosilicate particles have a specific surface area of 15.63 m²/g. Then the sodium aluminosilicate particles are soaked in a 4 mol/L sodium nitrate solution for 24 h. A volume of the sodium nitrate solution corresponding to 1 g of the sodium aluminosilicate particles is 40 mL. After the soaking, the sodium nitrate solution soaked with the sodium aluminosilicate is taken to perform solid-liquid separation through vacuum filtration to obtained filtered sodium aluminosilicate particles, followed drying the filtered sodium aluminosilicate particles at 105° C. and placing the filtered sodium aluminosilicate particles in a muffle furnace. The muffle furnace is then heated to 400° C. at a rate of 10 kelvins per minute (K/min), the temperature is maintained for 1 h, followed by cooling the muffle furnace to room temperature in a desiccator to obtain primary modified sodium aluminosilicate particles by sodium nitrate calcination (i.e., primary modified aluminosilicate particles).

After obtaining the primary modified sodium aluminosilicate particles by the sodium nitrate calcination, the primary modified sodium aluminosilicate particles by the sodium nitrate calcination are then soaked in a chitosan solution with a mass concentration of 5% at 50° C. for 1 h. A pH value of the chitosan solution is in a range of 9.5 to 10.5. After the soaking in the chitosan solution, the chitosan solution is taken to perform solid-liquid separation through vacuum filtration to obtain filtered primary modified sodium aluminosilicate particles, followed by washing the primary modified sodium aluminosilicate particles with water to obtain washed primary modified sodium aluminosilicate particles, and drying the washed primary modified sodium aluminosilicate particles at 100° C. to obtain the modified aluminosilicate inorganic mesoporous material. After testing, a specific surface area of the modified aluminosilicate inorganic mesoporous material is 35 m²/g.

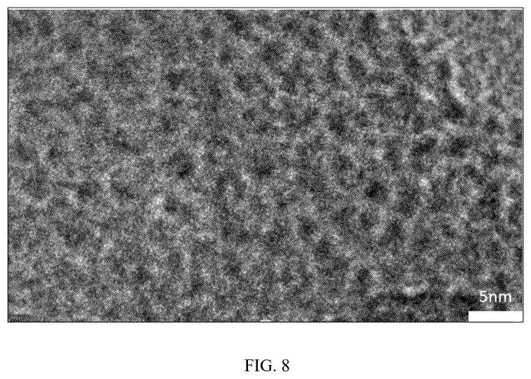

Scanning electron microscopy and transmission electron microscopy are used to scan and test the modified aluminosilicate inorganic mesoporous material prepared above. The scanning electron microscopy image of the internal pore structure of the modified aluminosilicate inorganic mesoporous material is shown in FIG. 7. It can be seen from FIG. 7 that there are 3 micrometers (μm) pores inside the modified aluminosilicate inorganic mesoporous material. The transmission electron microscope image of the internal pore structure of the modified aluminosilicate inorganic mesoporous material is shown in FIG. 8. It can be seen from FIG. 8 that there are 5 nm pores inside the modified aluminosilicate inorganic mesoporous material. From FIGS. 7 and 8, it can be seen that the internal pore size of the modified aluminosilicate inorganic mesoporous material obtained in the embodiment 3 is at a mesoporous level, even reaching a sub nanometer level.

### Embodiment 4

The difference between the embodiment 4 and the embodiment 3 is that the concentration of sodium nitrate used is 1 mol/L.

### Embodiment 5

The difference between the embodiment 5 and the embodiment 3 is that the concentration of sodium nitrate used is 2 mol/L.

### Embodiment 6

The difference between the embodiment 6 and the embodiment 3 is that the concentration of sodium nitrate used is 6 mol/L.

### Embodiment 7

The difference between the embodiment 7 and the embodiment 3 is that a volume of the nitrate solution corresponding to 1 g of the sodium aluminosilicate particles is 10 mL.

### Embodiment 8

The difference between the embodiment 8 and the embodiment 3 is that a volume of the nitrate solution corresponding to 1 g of the sodium aluminosilicate particles is 20 mL.

### Embodiment 9

The difference between the embodiment 8 and the embodiment 3 is that a volume of the nitrate solution corresponding to 1 g of the sodium aluminosilicate particles is 60 mL.

### Embodiment 10

The difference between the embodiment 10 and the embodiment 3 is that the muffle furnace is heated to 500° C. at a rate of 10 K/min, and then taken out after being maintained at 500° C. for 1 h.

### Embodiment 11

The difference between the embodiment 11 and the embodiment 3 is that the sodium aluminosilicate particles with 80 meshes to 100 meshes are soaked in a 4 mol/L potassium nitrate solution for 24 h. A volume of the potassium nitrate solution corresponding to 1 g of the sodium aluminosilicate particles is 40 mL.

### Embodiment 12

The difference between the embodiment 12 and the embodiment 3 is that natural potassium aluminosilicate is used instead of the natural sodium aluminosilicate.

### Embodiment 13

The difference between the embodiment 13 and the embodiment 3 is that natural calcium aluminosilicate is used instead of the natural sodium aluminosilicate.

### Embodiment 14

The difference between the embodiment 14 and the embodiment 3 is that natural calcium aluminosilicate, natural potassium aluminosilicate, and natural sodium aluminosilicate are used instead of the single natural sodium aluminosilicate.

### Comparative Example 1

The difference between the comparative example 1 and the embodiment 3 is that the concentration of sodium nitrate used is 0.5 mol/L.

### Comparative Example 2

The difference between the comparative example 2 and the embodiment 3 is that the concentration of sodium nitrate used is 10 mol/L.

### Comparative Example 3

The difference between the comparative example 3 and the embodiment 3 is that a volume of the nitrate solution corresponding to 1 g of the sodium aluminosilicate particles is 5 mL.

### Comparative Example 4

The difference between the comparative example 4 and the embodiment 3 is that a volume of the nitrate solution corresponding to 1 g of the sodium aluminosilicate particles is 100 mL.

### Comparative Example 5

The difference between the comparative example 5 and the embodiment 3 is that the muffle furnace is heated to 300° C. at a rate of 10 K/min, and then taken out after being maintained at 300° C. for 1 h.

### Comparative Example 6

The difference between the comparative example 6 and the embodiment 3 is that the muffle furnace is heated to 600° C. at a rate of 10 K/min, and then taken out after being maintained at 600° C. for 1 h.

Effects of using the modified aluminosilicate inorganic mesoporous material prepared in the embodiment 3 for treating sewage with different initial concentrations is shown in Table 2.

TABLE 2
Ammonia-nitrogen concentration, total phosphorus concentration and removal rate
before and after treatment under different initial concentrations of sewage

| | ammonia- | total | | ammonia- | | total | |
|---|---|---|---|---|---|---|---|
| | nitrogen | phosphorus | | nitrogen | ammonia - | phosphorus | total |
| | concentration | concentration | | concentration | nitrogen | concentration | phosphorus |
| | before | before | material | after | removal | after | removal |
| serial | reaction | reaction | dosage | reaction | rate | reaction | rate |
| number | (mg/L) | (mg/L) | (g/L) | (mg/L) | (%) | (mg/L) | (%) |
| 1 | 25 | 0.87 | 35 | 1.4 | 94.4 | 0.04 | 95.4 |
| 2 | 50 | 1.35 | 60 | 2.0 | 96 | 0.12 | 91.1 |
| 3 | 100 | 1.63 | 80 | 5.0 | 95 | 0.14 | 91.4 |
| 4 | 150 | 1.9 | 100 | 9.6 | 93.6 | 0.17 | 91.1 |
| 5 | 2 | 0.7 | 35 | 0.12 | 94 | 0.06 | 91.4 |

The technical solution provided in the disclosure achieves a removal rate of over 90% for ammonia-nitrogen in sewage with a concentration of 2 mg/L to 150 mg/L, and a removal rate of over 90% for the total phosphorus in the sewage with a concentration of 0.5 mg/L to 2 mg/L.

The modified aluminosilicate inorganic mesoporous material prepared in embodiments 3 to 6 and comparative examples 1 to 2 are used for denitrification and phosphorus removal of sewage with the same concentration. Before treatment, the initial concentration of ammonia-nitrogen in the sewage is 10 mg/L and the initial total phosphorus concentration is 1.5 mg/L. The dosage of the modified aluminosilicate inorganic mesoporous material is 35 grams per liter (g/L), and the reaction time is 1 day. The effects are shown in Table 3.

TABLE 3
Ammonia-nitrogen, total phosphorus concentration and removal rate before
and after the treatment under different concentrations of sodium nitrate

| | | Ammonia- | | Total | |
|---|---|---|---|---|---|
| | Sodium | nitrogen | Ammonia- | phosphorus | Total |
| | nitrate | concentration | nitrogen | concentration | phosphorus |
| | concentration | after reaction | removal | after reaction | removal |
| | (mol/L) | (mg/L) | rate (%) | (mg/L) | rate (%) |
| Comparative | 0.5 | 1.31 | 86.9 | 0.19 | 87.3 |
| Example 1 | | | | | |
| Embodiment | 1 | 1.22 | 87.8 | 0.18 | 88.0 |
| 4 | | | | | |
| Embodiment | 2 | 0.89 | 91.1 | 0.12 | 92.0 |
| 5 | | | | | |
| Embodiment | 4 | 0.82 | 91.8 | 0.09 | 94.0 |
| 3 | | | | | |
| Embodiment | 6 | 0.79 | 92.1 | 0.08 | 94.7 |
| 6 | | | | | |
| Comparative | 10 | 1.09 | 89.1 | 0.21 | 86.0 |
| Example 2 | | | | | |

According to Table 3, it can be seen that in the technical solution provided by the disclosure, when the concentration of sodium nitrate is low, the ion exchange capacity decreases, and the high temperature calcination of NO³⁻ can improve the pore structure of aluminosilicates to a limited extent. When the concentration of sodium nitrate is high, too much nitrate enters the interior of aluminosilicates, which can easily cause pore collapse after calcination. In a specific embodiment, the concentration of the sodium nitrate solution is between 1 mol/L and 6 mol/L.

The modified aluminosilicate inorganic mesoporous material prepared in the embodiments 3 and 7 to 9, and comparative examples 3-4 are used for denitrification and phosphorus removal of sewage with the same concentration. Before treatment, the initial concentration of ammonia-nitrogen in the sewage is 20 mg/L, and the initial total phosphorus concentration is 1.0 mg/L. The dosage of the modified aluminosilicate inorganic mesoporous material is 40 g/L, and the reaction time is 2 days. The effects are shown in Table 4.

TABLE 4
Concentrations and removal rates of ammonia-nitrogen and
total phosphorus after treatment under different solid-
liquid ratios of aluminosilicate and sodium nitrate

| | Solid-liquid | Ammonia- | | Total | |
|---|---|---|---|---|---|
| | ratio of | nitrogen | Ammonia- | phosphorus | Total |
| | aluminosilicate | concentration | nitrogen | concentration | phosphorus |
| | and sodium | after reaction | removal | after reaction | removal |
| | nitrate (g:mL) | (mg/L) | rate (%) | (mg/L) | rate (%) |
| Comparative | 1:5 | 2.25 | 88.8 | 0.25 | 75.0 |
| Example 3 | | | | | |
| Embodiment | 1:10 | 1.62 | 91.9 | 0.13 | 87.0 |
| 7 | | | | | |
| Embodiment | 1:20 | 1.51 | 92.5 | 0.11 | 89.0 |
| 8 | | | | | |
| Embodiment | 1:40 | 1.32 | 93.4 | 0.10 | 90.0 |
| 3 | | | | | |
| Embodiment | 1:60 | 1.28 | 93.6 | 0.08 | 92.0 |
| 9 | | | | | |
| Comparative | 1:100 | 1.29 | 93.6 | 0.09 | 91.0 |
| Example 4 | | | | | |

According to Table 4, in the technical solution provided by the disclosure, a small volume of sodium nitrate solution will limit cation exchange and nitrate attachment. The excessive volume of sodium nitrate solution has little effect on the improvement of pollutant adsorption rate by modified aluminosilicate. In a specific embodiment, the volume of the nitrate solution corresponding to 1 g of the aluminosilicate particles is between 10 mL and 60 mL.

The modified aluminosilicate inorganic mesoporous material prepared in the embodiments 3 and 10, and comparative examples 5 and 6 are used for denitrification and phosphorus removal of sewage with the same concentration. Before the treatment, the initial concentration of ammonia-nitrogen in the sewage is 20 mg/L, and the initial total phosphorus concentration is 1.0 mg/L. The dosage of the modified aluminosilicate inorganic mesoporous material is 35 g/L, and the reaction time is 2 days. The effects are shown in Table 5.

TABLE 5
Concentrations and removal rates of ammonia-nitrogen and total phosphorus
before and after the treatment under different calcination temperatures

| | | Ammonia- | | Total | |
|---|---|---|---|---|---|
| | | nitrogen | Ammonia- | phosphorus | Total |
| | Calcination | concentration | nitrogen | concentration | phosphorus |
| | temperatures | after reaction | removal | after reaction | removal |
| | (° C.) | (mg/L) | rate (%) | (mg/L) | rate (%) |
| Comparative | 300 | 3.63 | 81.85 | 0.37 | 63 |
| Example 5 | | | | | |
| Embodiment | 400 | 1.62 | 91.9 | 0.11 | 89 |
| 3 | | | | | |
| Embodiment | 500 | 1.45 | 92.75 | 0.09 | 91 |
| 10 | | | | | |
| Comparative | 600 | 1.96 | 90.2 | 0.12 | 88 |
| Example 6 | | | | | |

According to Table 5, it can be seen that in the technical solution provided by the disclosure, the calcination temperature is too low (below 400° C.) to have a significant hole expansion effect. Excessive calcination temperature (above 500° C.) can easily cause the collapse of the aluminosilicate framework. In a specific embodiment, the calcination temperature is between 400° C. and 500° C.

Although the specification is described according to the embodiments, not each embodiment only contains an independent technical solution. This description in the specification is only for clarity. Those skilled in the art should consider the specification as a whole, and the technical solutions in each embodiment can also be appropriately combined to form other embodiments that can be understood by those skilled in the art.

A series of detailed explanations listed above are only specific explanations of the embodiments of the disclosure, and they are not intended to limit the scope of protection of the disclosure. Any equivalent embodiments or changes that do not deviate from the technical spirit of the disclosure should be included in the scope of protection of the disclosure.

What is claimed is:

1. An ecological dam for nitrogen fixation and phosphorus reduction based on a modified aluminosilicate inorganic mesoporous material, comprising:
an ecological adsorption module, wherein the ecological adsorption module is located in a river channel to be treated, the ecological adsorption module comprises a plurality of ecological adsorption ball components prepared from the modified aluminosilicate inorganic mesoporous material, and the ecological adsorption module is configured to adsorb pollutants in the river channel to be treated; and
a fixing module, wherein the fixing module is disposed in the river channel to be treated, and the fixing module comprises a plurality of vertical fixing piles and a plurality of horizontal support angle steels; the plurality of vertical fixing piles are arranged in two symmetrical rows on two riverbanks of the river channel to be treated, any two vertical fixing piles symmetrically arranged of the plurality of vertical fixing piles is fixed with a corresponding one of the plurality of horizontal support angle steels therebetween, and the plurality of ecological adsorption ball components of the ecological adsorption module are mounted on the plurality of horizontal support angle steels;
wherein a preparation method of the modified aluminosilicate inorganic mesoporous material comprises:
S1, crushing aluminosilicate, and followed by selecting aluminosilicate particles in a range of 80 meshes to 100 meshes;
S2, soaking the aluminosilicate particles from the step S1 in a nitrate solution with a concentration of 1 mole per liter (mol/L) to 6 mol/L for 12 hours (h) to 24 h to obtain a mixed solution, wherein a volume of the nitrate solution corresponding to 1 gram (g) of the aluminosilicate particles is in a range of 10 milliliters (mL) to 60 mL; filtering the mixed solution to obtain filtered particles, followed by drying the filtered particles at a temperature in a range of 95° C. to 110° C., and then calcining the filtered particles after the drying at a temperature in a range of 400° C. to 500° C. for 1 h to 2 h to obtain primary modified aluminosilicate particles; and
S3, soaking the primary modified aluminosilicate particles from the step S2 in a chitosan solution with a mass concentration in a range of 3% to 5% at a temperature in a range of 40° C. to 60° C. for 0.5 h to 3 h, then filtering the chitosan solution soaked with the primary modified aluminosilicate particles to obtain filtered primary modified aluminosilicate particles, followed by washing the filtered primary modified aluminosilicate particles with water to obtain washed primary modified aluminosilicate particles, and drying the washed primary modified aluminosilicate particles at a temperature in a range of 95° C. to 110° C. to obtain the modified aluminosilicate inorganic mesoporous material;
wherein a specific surface area of the modified aluminosilicate inorganic mesoporous material is in a range of 30 square meters per gram (m²/g) to 40 m²/g;
wherein each ecological adsorption ball component comprises a sinking ball and a plurality of floating balls vertically connected in series from a water bottom to a water surface in the river channel to be treated;
wherein each floating ball comprises a spherical shell including an outer shell and an inner shell adjacent thereto, the outer shell is a grid shell with a grid aperture of 1 centimeter (cm)×2 cm, and the inner shell is made of an 80-mesh nylon fabric; the spherical shell defines a hollow sphere cavity, the hollow sphere cavity is sequentially filled with a layer of the modified aluminosilicate inorganic mesoporous material and a pearl cotton layer from bottom to top, a plurality of slow-release nitrifying bacteria solid balls are filled in the pearl cotton layer, and the layer of the modified aluminosilicate inorganic mesoporous material comprises, from bottom to top, three sub-layers of the modified aluminosilicate inorganic mesoporous material of with particle sizes of 2 cm to 4 cm, 1 cm to 2 cm, and 1 millimeter (mm) to 4 mm;
wherein the sinking ball comprises a spherical shell including an outer shell and an inner shell adjacent thereto, the outer shell is a grid shell with a grid aperture of 1 cm×2 cm, and the inner shell is made of an 80-mesh nylon fabric; the spherical shell defines a hollow sphere cavity, the hollow sphere cavity is sequentially filled with a layer of the modified aluminosilicate inorganic mesoporous material and a plurality of slow-release nitrifying bacteria solid balls, and the layer of the modified aluminosilicate inorganic mesoporous material comprises, from bottom to top, three sub-layers of the modified aluminosilicate inorganic mesoporous material with particle sizes of 2 cm to 4 cm, 1 cm to 2 cm, and 1 mm to 4 mm; and
wherein the three sub-layers of the modified aluminosilicate inorganic mesoporous material with the particle sizes of 2 cm to 4 cm, 1 cm to 2 cm, and 1 mm to 4 mm are prepared from the modified aluminosilicate inorganic mesoporous material with the specific surface area in the range of 30 m²/g to 40 m²/g.

2. The ecological dam as claimed in claim 1, wherein in each floating ball, a weight ratio of the layer of the modified aluminosilicate inorganic mesoporous material to the pearl cotton layer is in a range of 50:1 to 70:1, and a weight ratio of the pearl cotton layer to the plurality of slow-release nitrifying bacteria solid balls is in a range of 0.5 to 1.

3. The ecological dam as claimed in claim 2, wherein a weight of the layer of the modified aluminosilicate inorganic mesoporous material is 1.5 kilograms (kg), a weight of the pearl cotton layer is 25 grams (g), and a weight of the plurality of slow-release nitrifying bacteria solid balls is 40 g.

4. The ecological dam as claimed in claim 1, wherein in the sinking ball, a weight ratio of the layer of the modified aluminosilicate inorganic mesoporous material to the plurality of slow-release nitrifying bacteria solid balls is in a range of 0.02 to 0.03.

5. The ecological dam as claimed in claim 1, wherein a distance between adjacent two of the plurality of vertical fixing piles on a same row is 50 cm, lower ends of the plurality of vertical fixing piles are at least 1 meter (m) deep into the water bottom of the river channel to be treated, and upper ends of the plurality of vertical fixing piles are in a range of 25 cm to 35 cm deep into the water surface of the river channel to be treated.

6. The ecological dam as claimed in claim 1, wherein each horizontal support angle steel defines laser holes, a diameter of each laser hole is in a range of 0.4 cm to 0.6 cm, and a distance between adjacent two of the laser holes is 15 cm.
